(19) United States
(12) Patent Application Publication
(10) Pub. No.: US 2003/0083854 A1
(43) Pub. Date: May 1, 2003

(54) Particle control using a path

(76) Inventor: Thomas M. Cronin, Hillsboro, OR (US)

Correspondence Address: FISH & RICHARDSON, PC, 4350 LA JOLLA VILLAGE DRIVE, SUITE 500, SAN DIEGO, CA, 92122, US

(21) Appl. No.: 10/053,072

(22) Filed: Oct. 26, 2001

(51) Int. Cl. G06F 17/10

(52) U.S. Cl. 703/2

(57) ABSTRACT

A method of modeling a particle system composed of particles having attributes includes receiving a definition of a particle path, modifying at least one attribute of a particle based on a distance between the particle and the particle path, and rendering the particles. The method may also include receiving particle attribute information and generating a set of attributes based on the particle attribute information.

### TECHNICAL FIELD

This invention relates to modeling and controlling particles using a path.

### BACKGROUND

Particle systems are often used to model animations of “flowing” systems, that is, modeling a set of objects that possess some common characteristics and/or movements. For example, particle systems are sometimes used to model water falling, smoke rising from a chimney, a flock of birds flying, snow falling, schools of fish swimming, etc.

A particle system is essentially a set of rules that are used to define how to “generate” and “render” particles for display on a display device such as a computer display screen. Generating particles includes defining particle attributes for each particle to be modeled. For example, particle attributes may include an age, a physical position, a velocity (speed and direction), a color and a size. Typically, following particle generation, a computer processor is used to render the particles by converting the particle attributes for each particle into display device information. The display device information is then used to output the rendered particle information by controlling individual pixels on the display device. Individual particles may be rendered and displayed as dots, lines, polygons or more complex objects.

To create an animation using a particle system, particle “movements” are displayed in a series of frames where the particle attributes are up-dated, rendered and then displayed on the display device. Typically frame up-dates occur 50-60 times per second. Particle system animations may model thousands of individual particles. Therefore, to transmit a particle system animation over an electronic network from a first computer to a second computer requires a large amount of bandwidth. For example, to display a particle system animation on a client computer that is defined by a server computer on the Internet, the server computer must transmit large amounts of particle information to a client on a frame-by-frame basis.

### DESCRIPTION OF DRAWINGS

FIG. 1 shows a block diagram of an electronic network having a server computer and a client computer;

FIGS. 2A and 2B shows abstract representations of a path construct defined by control points and connected by a spline curve;

FIG. 3 is a flowchart showing a particle system animation process using a path construct; and

FIG. 4 is a block diagram of computer hardware on which the particle system animation process may be implemented.

### DESCRIPTION

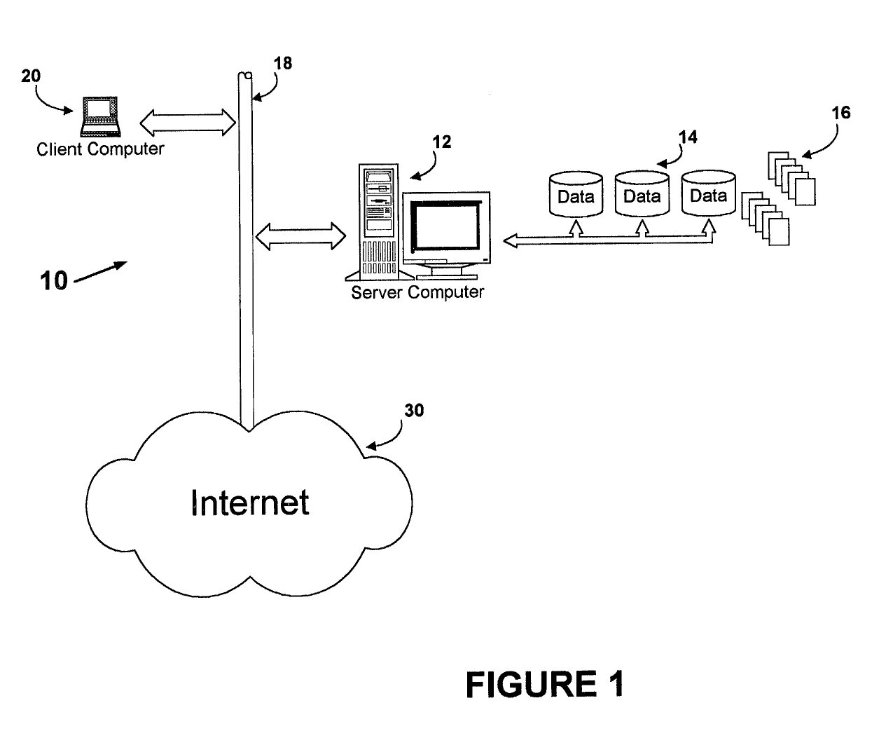

Referring to FIG. 1, an electronic network 10 that is used to transfer particle system information includes a server computer 12 (a “server”) and a client computer 20 (a “client”) that are both connected to send and receive data over a network link 18. Network link 18, may be operated as a “private” or a “public” network, for example, network link 18 could be a local area network, or, network link 18 could be a public network, such as an Internet 30. Server 12 is also connected to one or more storage devices 14 that contain files 16 (e.g., data and programs).

In electronic network 10, to model and display a particle animation on client 20, server 12 sends data that defines a particle “control” path over network link 18 to client 20. A path is a mathematically-defined continuous connection of a set of points, where each point is defined by axial coordinates that correspond to coordinates on a display device. “Control” refers to an algorithm associated with the path that is used to change a particle's attribute during a frame up-date. For example, a control algorithm may change a particle attribute based on a determined distance between the particle and the closest point on the path to the particle during a frame up-date.

Client 20 uses the control path definition to change particle attributes for particles included in the particle animation in a series of up-dates. The changed particle attributes are then rendered and displayed as a series of frames on a display device. This way of modeling and displaying a particle animation on client 20 does not require server 12 to generate and up-date individual particle attributes for client 20. Instead, the generation, up-dating and rendering of particles is performed on client 20. Therefore, even a complex particle path that is being used to animate thousands of particles may be achieved by passing a small amount of information over network 18 that requires relatively little bandwidth. Furthermore, server 12 does not need to send the particle generation information for a set of particles, instead client 20 may generate an initial set of particle attributes and then update and render the particles using the control path construct sent by server 12. Also, since client 20 performs the rendering, a user on client 20 can interact with the particle animation to make changes to the displayed screens without having to wait for communication of those changes between client 20 and server 12.

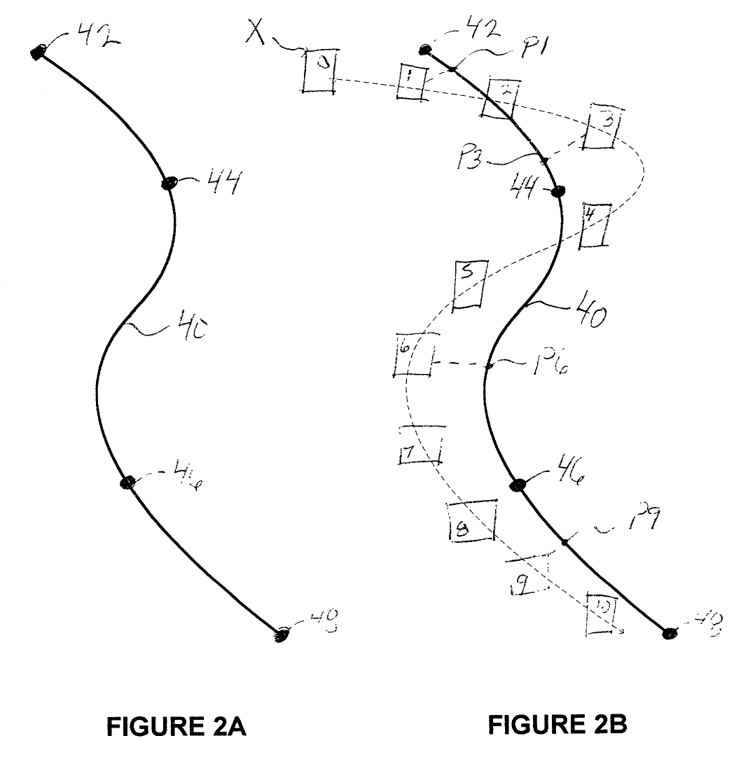

Referring to FIG. 2A, a representation of a particle control path 40 is shown as a continuous path 40 that has been interpolated between a series of points 42, 44, 46 and 48. Each point 42, 44, 46 and 48 is defined by axial coordinates that correspond to axial coordinates on the display device controlled by the client 20. In a particle system animation, in order to display particle movements that appear “smooth” and “natural”, the connection of the points included in the path must also be done smoothly. One way of connecting points smoothly is with a “spline curve”, i.e. a mathematically-defined algorithm that is used to interpolate curves between points that avoids the sharp corners that might occur if connecting directly from point-to-point with straight lines. Not all spline curves actually connect with each defined point. In one embodiment, the points are connected with a “Catmull-Rom” spline curve, which is an interpolated curve that passes through all points. It is noted that any mathematical construct that enables an interpolation of a line between points could be used.

Referring to FIGS. 2A and 2B, a representation of control path 40, that connects points 42, 44, 46 and 48, is generated using software. To illustrate the use of control path 40 in a particle animation, an exemplary particle X is shown (See FIG. 2B) being influenced by control path 40 in a series of eleven (11) frame up-dates 0-10. In this example, particle X's attributes include an initial position, velocity (speed and direction) and an “age”. In this example, particle X's age begins at age zero, and the age increases by one during each frame update. During each frame up-date 0-10, an “attractor point” is determined for particle X, i.e., the closest point on control path 40 to particle X. In operation, during up-date frame 1, point P1 is the determined attractor point, during up-date frame 3, point P3 is the determined attractor point, and so forth. The determined attractor point is then used to determine the distance between particle X and the current attractor point. In this example, the control algorithm associated with path 40 is defined to “attract” particle X towards the determined attractor point. The amount of “attractive force” towards path 40 is based on the determined distance between the particle and the attractor point. The determined attractive force (or alternatively, a repulsive force) will cause a change to one or more of the particle X's attributes, e.g., physical position, speed and/or velocity of the particle. It is noted that particle X is generally closest to an attractor point that is between two of the set of points 42, 44, 46 and 48.

Continuing with this example, after particle X's attributes are up-dated, particle X is rendered and displayed on a client 20 display device. The resulting animated “movement” of particle X from frame-to-frame is a relatively smooth “flow”, that is, with some variation in the movement of particle X according to its age, and proximity to different attractor points on control path 40. As stated previously, generally, during a frame up-date, the attractor point on control path 40 will be between two of the set of points 42, 44, 46 and 48, therefore, the location of the attractor point will be interpolated from the mathematically-defined path construct used to connect the points 42, 44, 46 and 48.

The control algorithm that is used to define a the change to a particle attribute may vary. Typically, an algorithm includes a set of variable definitions, for example:

‘d’ (A distance from the closest point on the path to the particle being up-dated);

‘c’ (A constant value that may be set by the programmer or a user); and

‘f’ (An amount of attractive force, i.e., the amount of force to applied from the current position of the particle towards the attractor point on the path).

Using these variable definitions, exemplary control algorithms could be defined as follows:

1) f=d×c; This algorithm enables the application of a force that is determined by the distance multiplied by the constant;

2) f=d×d×c; This algorithm enables the application of a force that is determined by the distance squared(d×d); and

3) f=c; This algorithm enables the application of a force that is determined from, and equal to, the constant (c).

Other control algorithms could be used, for example, control algorithms that include more variables, e.g.:

‘r’; A radius (a distance) from the closest point to the particle where no force will be applied.

As an example of a control algorithm that uses the variable ‘r’:

4) f=(d−r)×c; This algorithm enables the application of a force to a particle only when the particle is outside of the radius distance, ‘r’.

It is noted that other particle attributes besides a particle's age could be used to determine when and how to influence a particle attribute with a path construct, for example, a particle's velocity or color could be used. Also, it is noted that the path curve representations shown in FIGS. 2A and 2B are not, generally, rendered or displayed as part of the particle animation, instead, FIGS. 2A and 2B are abstract representations of the continuous path connection interpolated between a set of points.

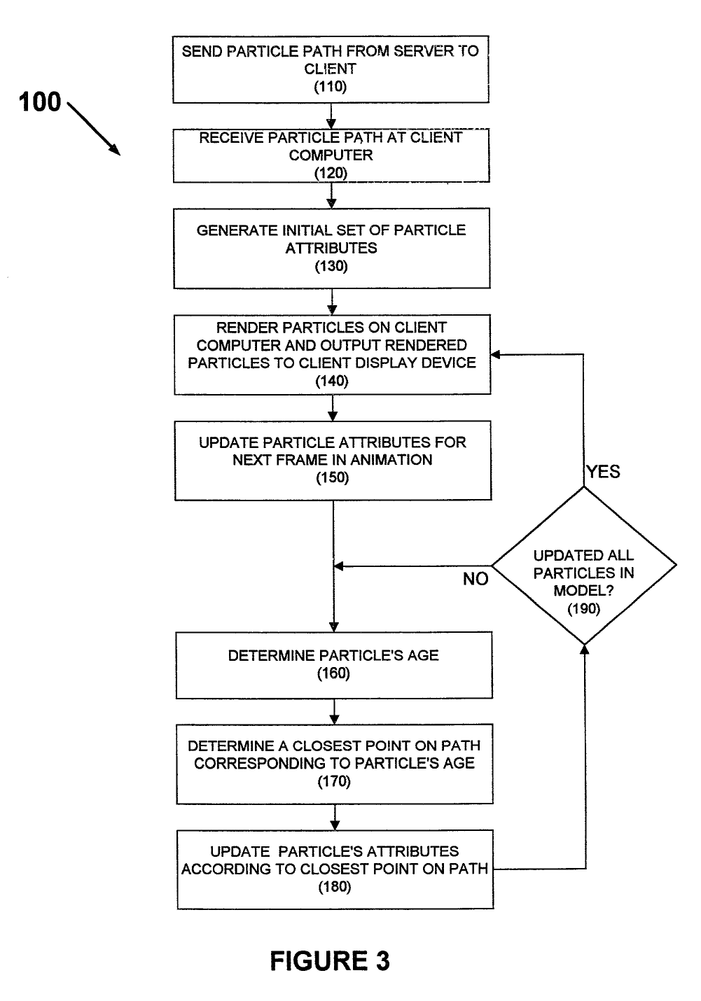

Referring to FIG. 3, a process 100 is shown for performing a particle animation. Process 100 includes sending 110 a particle path from a server to a client, receiving 120 the particle path at the client, generating 130 an initial set of particle attributes, rendering and outputting 140 particles on the client display device, up-dating 150 particle attributes during a frame up-date, determining 160 each particle's age, determining 170 a closest point on path to the particle being up-dated, up-dating 180 the particle's attributes according to the determined closest point on the path, and, determining 190 whether all particles in the animation have been up-dated. If all particles have not been up-dated, method 100 repeats the sequence of actions 160, 170 and 180 and 190. If all particles have been up-dated, method 100 returns to rendering and outputting 140 the up-dated frame on the client display device.

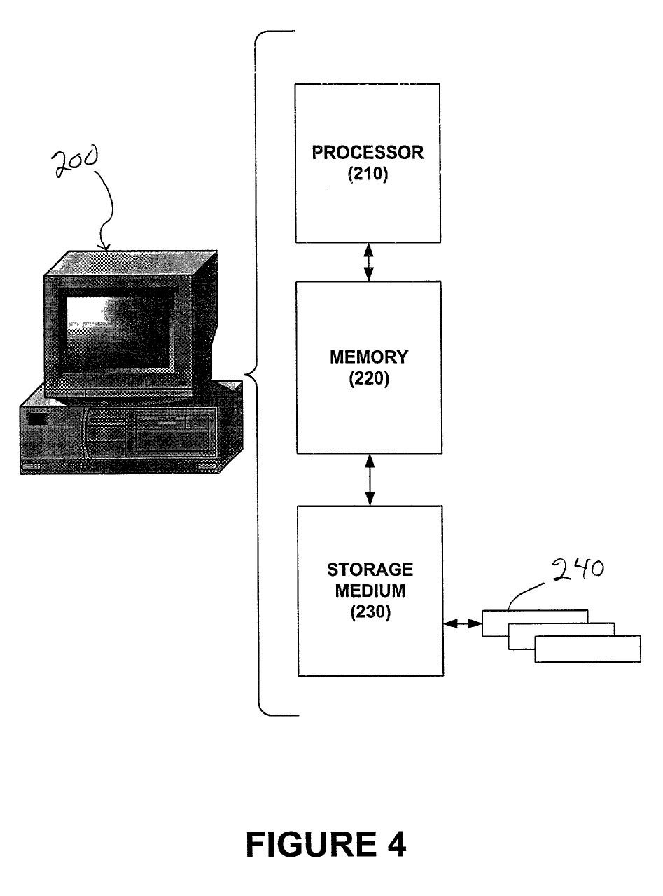

FIG. 4 shows a personal computer 200 on which process 100 may be implemented. Computer 200 includes a processor 210, a memory 220, and a storage medium 230. Storage medium 230 stores data for one or more particle system animations and machine-executable instructions 240 that are executed by processor 210 out of memory 220 to perform process 100.

Although a personal computer 200 is shown in FIG. 4, process 100 is not limited to use with the hardware and software of FIG. 4. It may find applicability in any computing or processing environment. Process 100 may be implemented in hardware, software, or a combination of the two. Process 100 may be implemented in computer programs executing on programmable computers or other machines that each include a processor, a storage medium readable by the processor (including volatile and non-volatile memory and/or storage components), at least one input device, and one or more output devices. Program code may be applied to data entered using an input device (e.g., a mouse or keyboard) to perform process 100 and to generate output information.

Each such program may be implemented in a high level procedural or object-oriented programming language to communicate with a computer system. However, the programs can be implemented in assembly or machine language. The language may be a compiled or an interpreted language.

Each computer program may be may be implemented as one or more articles of manufacture (storage media), such as a CD-ROM, hard disk, or magnetic diskette, that is readable by a general or special purpose programmable computer for configuring and operating the computer when the storage medium or device is read by the computer to perform process 100. Process 100 may also be implemented as a machine-readable storage medium, configured with a computer program, where, upon execution, instructions in the computer program cause a machine to operate in accordance with process 100.

Particle animations are generally used to animate only a portion of a computer display device and are commonly rendered in a “third-dimension” (“3D”). More specifically, an initial two-dimensional (“2D”) background is rendered and displayed, then other “3D” objects are rendered and displayed in front of the 2D background display. As an example, an initial 2D background display might include a mountain and a night sky above, then a house with a chimney is rendered and displayed in “3D”, that is, in front of the mountain and sky 2D background. A particle system might be specified in 3D space and used to animate smoke that rises from the chimney and into the night sky. The particle path may then be used to animate the movements of the generated smoke particles away from the chimney peak and rising towards the sky. It is noted that particle animations may also be specified, rendered and displayed in “2D”.

Though specific embodiments have been described other ways to implement the features of those embodiments are possible. For example, multiple paths may be defined for a particle animation, where different paths are defined by different sets of control points and, therefore, may cause different degrees or amounts of change to a particle's attributes.

A number of embodiments of the invention have been described. Nevertheless, it will be understood that various modifications may be made without departing from the spirit and scope of the invention. Accordingly, other embodiments are within the scope of the following claims.

What is claimed is:

1. A method of modeling a particle system composed of particles having attributes, comprising:
receiving a definition of a particle path;
modifying at least one attribute of a particle based on a distance between the particle and the particle path; and
rendering the particles.

2. The method of claim 1, further comprising:
receiving particle attribute information; and
generating a set of attributes based on the particle attribute information.

3. The method of claim 1, wherein receiving comprises:
receiving coordinates for a set of points that are continuously connected using a mathematical construct; and
receiving a control algorithm corresponding to the particle path.

4. The method of claim 3, wherein the mathematical construct comprises a spline curve.

5. The method of claim 4, wherein the spline curve comprises a Catmull-Rom spline curve.

6. The method of claim 4, wherein modifying further comprises:
determining a distance between the particle and a closest point on the path; and
determine an amount of change to the particle attribute based on the distance.

7. The method of claim 4, wherein the control algorithm is defined to change at least one of a position attribute, a color attribute and a size attribute of the particle during an up-date cycle.

8. The method of claim 7, further comprising:
determining an occurrence of the up-date cycle according to one of a particle's age, position, color and size.

9. The method of claim 6, wherein modifying further comprises:
modifying the particle attribute an amount that varies based on the distance.

10. The method of claim 6, wherein the particle system is a three-dimensional particle system and the particles are defined by three-dimensional coordinates.

11. A article comprising a machine-readable medium that stores machine-executable instructions for modeling a particle system composed of particles having attributes, the instructions causing a machine to:
receive a particle path definition;
modify at least one attribute of a particle based on a distance between the particle and the particle path; and
render the particles.

12. The article of claim 11, further comprising instructions that cause the machine to:
receive particle attribute information; and
generate a set of attributes based on the particle attribute information.

13. The article of claim 11, wherein receive comprises:
receive coordinates for a set of points;
connect each of the set of points continuously based on a mathematical construct; and
receiving a control algorithm definition corresponding to the particle path.

14. The article of claim 13, wherein the mathematical construct comprises a spline curve.

15. The article of claim 14, wherein the spline curve comprises a Catmull-Rom spline curve.

16. The article of claim 14, wherein modifying further comprises instructions that cause the machine to:
determine a distance between the particle and a closest point and the particle; and
determine an amount of change to the particle attribute based on the distance.

17. The article of claim 14, wherein one the control algorithm is defined to change at least one of a position attribute, a color attribute and a size attribute of the particle during an up-date cycle.

18. The article of claim 17, further comprising instructions that cause the machine to:
determine an occurrence of the up-date cycle according to one of a particle's age, position, color and size.

19. The article of claim 16, wherein modifying further comprises instructions causing the machine to:
modify the particle attribute an amount that varies based on the distance.

20. The article of claim 16, wherein the particle system is a three-dimensional particle system and the particles are defined by three-dimensional coordinates.

21. An apparatus for modeling a particle system composed of particles having attributes, comprising:
a memory that stores executable instructions; and
a processor that executes the instructions to:
receive a particle path definition;
modify at least one attribute of a particle based on a distance between the particle and the particle path; and
render the particles.

22. The apparatus of claim 21, wherein the processor executes instruction to:
receive particle attribute information; and
generate a set of attributes based on the particle attribute information.

23. The apparatus of claim 21, wherein receive comprises:
receive coordinates for a set of points;
connect continuously each of the set of points using a mathematical construct; and
receive a control algorithm definition corresponding to the particle path.

24. The apparatus of claim 23, wherein the mathematical construct comprises a spline curve.

25. The apparatus of claim 24, wherein the spline curve comprises a Catmull-Rom spline curve.

26. The apparatus of claim 25, wherein modifying further comprises instructions that cause the machine to:
determine a distance between the particle and a closest point on the particle path; and
determine an amount of change to the particle attribute based on the distance.

27. The apparatus of claim 24, wherein the control algorithm is defined to change at least one of a position attribute, a color attribute and a size attribute of the particle during an up-date cycle.

28. The apparatus of claim 27, further comprising instructions that cause the machine to:
determine an occurrence of the up-date cycle according to one of a particle's age, position, color and size.

29. The apparatus of claim 26, wherein modifying further comprises instructions that cause the machine to:
modify the particle attribute an amount that varies based on the distance.

30. The apparatus of claim 26, wherein the particle system is a three-dimensional particle system and the particles are defined by three-dimensional coordinates.
